(19) United States
(12) Patent Application Publication
(10) Pub. No.: US 2017/0335587 A1
(43) Pub. Date: Nov. 23, 2017

(54) Portable Building Containing Cabinets for Safely Storing Hazardous Production Materials

(71) Applicant: The Boeing Company, Chicago, IL (US)

(72) Inventors: Matthew L. Prendergast, Covington, WA (US); Randall B. Carey, Kent, WA (US); Thomas W. Hanson, Burien, WA (US)

(73) Assignee: The Boeing Company, Chicago, IL (US)

(21) Appl. No.: 15/161,889

(22) Filed: May 23, 2016

(51) Int. Cl. E04H 5/02; E04H 9/14; E04H 1/00; A62C 3/00; E04C 2/52; E04B 1/94; F24F 1/04; E04H 1/12

(52) U.S. Cl. CPC E04H 5/02; F24F 1/04; E04H 9/14; E04H 1/125; E04H 1/1205; A62C 3/002; E04C 2/528; E04C 2/521; E04B 1/948; E04H 1/005

(57) ABSTRACT

A storage system comprising a portable building having a climate-controlled interior space and a plurality of hazardous materials storage cabinets disposed in the interior space. The portable building contains no water sprinklers and no smoke detectors and has a floor that is sealed to prevent leakage of liquid. Each cabinet comprises metal double walls separated by an air space and a liquid-tight containment sump. Each cabinet is configured so that fire cannot spread from a space above a shelf to a space below the shelf. The storage system further comprises an electrical power connection and an HVAC unit mounted to an exterior of the portable building.

### BACKGROUND

This disclosure generally relates to systems and methods for storing hazardous materials such as chemicals used at production facilities.

It is important to assure that solvents, lubricants, paint-related products and similar hazardous materials employed at production facilities are handled and stored with adequate safeguards. Adequate safeguards are generally defined by a set of safety or fire code requirements with the goal to provide a level of protection from fire and safety hazards. An inspection and certification process needs to be successfully passed to meet these requirements. Typically, the size of a building is the main trigger from a fire code perspective for an automatic fire suppression system. One type of automatic fire suppression system comprises water sprinklers, which in turn requires connection to a water source using water pipes. The associated water pipes are commonly required to be trenched underground at sufficient depth (around at least 3 feet below ground surface) to protect from freezing. Often the water pipes are required to be made from corrosion-resistant materials, such as cement-lined iron piping.

Currently, depending on the size and occupancy of a storage building, it can be subject to stricter safety or fire code requirements, such as the provision of a smoke detector, the provision of a 24/7 fire monitoring alarm with associated monthly fees, and recurrent (every 6 months, for example) fire inspection by a fire marshal.

In particular, the storage facility should be constructed to achieve the following: (a) avoid any direct contact between an ignition source and the stored hazardous materials; (b) avoid contact between two incompatible hazardous materials; (c) avoid environmental pollution subsequent to a spill in the installation; (d) prevent rapid flame spread within the structure or occupancy; and (e) in the event of an accident, fire or explosion, prevent propagation of damage to outside the boundaries of the installation. Even small spills and relatively minute leakages of hazardous material can detrimentally affect personnel, property, plants, animals, groundwater and other aspects of ecology and environment.

It is known to provide safety enclosures of a type that is referred to as secondary containment buildings, namely, walk-in storage structures that have walls and roofs that typically are formed from metal, that typically are used to store containers of hazardous materials, and that customarily are provided with sump-type secondary containment vessels into which spillage and leakage are directed for temporary collection and safe disposal.

In accordance with one solution located outside an existing production facility, containers of hazardous material are stored on shelves inside a relatively expensive non-portable leak-proof building which is equipped with smoke/fire detectors, alarms, an automatic fire suppression system, and spill/deluge waste containment. The installation and maintenance of water sprinklers and fire detectors increases the costs associated with such buildings.

In addition, the placement of a storage building for storing hazardous materials outside a production facility requires that personnel who want to use a hazardous material at a stall inside the production facility must travel back and forth between the storage building and the stall. For example, some hazardous materials are prohibited from being outside the climate-controlled storage facility for more than a specified time duration (e.g., one hour). As a result, someone must return the hazardous material to the storage facility upon expiration of the specified time duration. The distances traveled during trips back and forth between a stall and the storage facility represent lost time and reduced productivity.

A further disadvantage is that the current deployment of storage containers in a non-portable building renders the facility configuration layout inflexible (i.e., not readily reconfigurable). Any relocation of the storage unit will require remodeling of the facility to re-route water pipes (for example) and multiple inspection visits by the fire department.

Another solution to the problem of storing hazardous or flammable materials is to deploy much smaller noncombustible cabinets, such as the ones described in U.S. Pat. No. 8,172,344, throughout the facility. However, these do not provide adequate temperature- and humidity-controlled protection of the stored products. In some instances, the chemical composition of stored hazardous materials can be adversely impacted by temperature change and thus spoiled and unable to be re-used.

In summary, some current solutions provide adequate products protection and storage, and enable re-usability of the stored products. However, they are expensive and do not enable a flexible layout reconfiguration of the production facility. Other current solutions are simple and inexpensive, but do not provide adequate storage and protection of the products.

It would be desirable to provide a building for storing hazardous materials within an open production facility (the building should not be located indoors) that reduces the costs associated with installation of the building, reduces the costs associated with travel of personnel between the storage building and the location where the hazardous material is used, and enables a flexible facility configuration layout within the production facility.

### SUMMARY

The subject matter disclosed in detail below is directed to deployment and use of a portable building having a climate-controlled interior space in which a plurality of noncombustible hazardous material storage cabinets are placed. The storage cabinets are designed to provide spill containment and fire protection. More specifically, each cabinet comprises metal double walls separated by an air space and a liquid-tight containment sump, and each cabinet is configured so that fire is less able to spread from a space above a shelf to a space below the shelf.

The foregoing arrangement enables low-cost storage of hazardous materials. Depending on the jurisdiction, the applicable safety and fire code may not require the installation or maintenance of smoke/fire detectors, alarms, an automatic fire suppression system, and spill/deluge waste containment. The use of portable buildings equipped with noncombustible cabinets is a low-cost storage option that will allow temperature-controlled storage of chemicals without the need for more expensive fire monitoring and control systems. In some embodiments, the portable building can be moved using a forklift or other lifting apparatus. In other embodiments, the portable building may be equipped with wheels and towed (or driven) to a site.

Because a portable building equipped with cabinets allows the storage of small volumes of hazardous or flammable materials in separate compartments, the applicable safety or fire code in a particular jurisdiction may not require an automatic fire suppression system. Thus, the portable building can be moved to a new site within the production facility without incurring costs associated with connecting the building to a water supply using water pipes. Also, the cost of installing an automatic fire suppression system is avoided. Thus, the presence of the portable building inside an open production facility poses no impediment to the reconfiguration of the facility configuration layout.

One aspect of the subject matter disclosed in detail below is a method for storing hazardous or flammable materials for use in a production facility, comprising: (a) placing a portable building at a first location within the production facility in accordance with a first facility configuration layout and without connecting the portable building to a water source using pipes; (b) storing hazardous or flammable materials inside the portable building in compliance with an applicable safety code governing the storage of hazardous or flammable materials while the portable building is at the first location; (c) specifying a second facility configuration layout different than the first facility configuration layout; (d) moving the portable building to a second location within the production facility in accordance with the second facility configuration layout without connecting the portable building to a water source using pipes; and (e) storing hazardous or flammable materials inside the portable building in compliance with the applicable safety code while the portable building is at the second location.

In accordance with some embodiments, the method described in the preceding paragraph further comprises placing a plurality of cabinets inside the portable building, each of the cabinets having a construction designed to contain fire and spills, wherein steps (b) and (e) each comprise storing hazardous or flammable materials inside the plurality of cabinets.

Another aspect of the subject matter disclosed in detail below is a storage system for hazardous or flammable materials comprising: a portable building not equipped with an automatic fire suppression system and not connected to a water source by pipes; and a cabinet disposed in the interior space of the portable building, wherein the cabinet is constructed to contain fire and spills in compliance with an applicable safety code governing the storage of hazardous or flammable materials without any connection to a water source. In addition, the portable building contains neither a smoke detector nor a fire monitoring system.

In accordance with some embodiments of the storage system described in the preceding paragraph, the portable building comprises a plurality of walls, a door mounted to one of the plurality of walls, and a floor that is sealed to the walls to prevent leakage of liquid from the portable building in the event of a spill, wherein the wall to which the door is mounted comprises a wall section that extends upward from the floor to a bottom of the door. The floor of the portable building does not incorporate a liquid collection system. The walls are made of non-combustible material and are sealed to each other to prevent leakage of liquid from the portable building.

The above-described storage system further comprises: a power connection mounted to the portable building; and an HVAC unit mounted to an exterior of the portable building, wherein the HVAC unit provides adequate temperature and/or humidity (either one or both) control for preventing spoilage or fuming of the hazardous or flammable materials; and wherein the adequate temperature and humidity control prevents the chemical composition of stored hazardous materials from being adversely impacted by temperature and/or humidity changes, thereby enabling the materials to be re-used.

A further aspect of the subject matter disclosed in detail below is a storage system comprising: a portable building that is not connected to a water source using pipes; and a plurality of cabinets disposed in the interior space of the portable building, wherein each cabinet of the plurality of cabinets comprises metal double walls separated by an air space and a liquid-tight containment sump. Each cabinet is constructed to contain fire and spills in compliance with an applicable safety code governing the storage of hazardous or flammable materials without any connection to a water source. The portable building does not contain any of the following: an automatic fire suppression system, a smoke detector, a fire monitoring system, and a liquid collection system.

Other aspects of systems and methods for storing and containing hazardous materials in a portable building that is deployable inside a production facility are disclosed below.

### BRIEF DESCRIPTION OF THE DRAWINGS

FIG. 1 is a diagram showing a facility configuration layout for an aircraft production facility having a building for storing hazardous materials located outside but near to the production facility.

FIG. 2 is a diagram showing a facility configuration layout for an aircraft production facility having a building for storing hazardous materials located inside the production facility.

FIG. 3 is a diagram representing an end view of a portable building for storing hazardous materials in accordance with one embodiment.

FIG. 4 is a diagram representing a side view of the portable building depicted in FIG. 3.

FIG. 5 is a diagram representing a sectional view of a portion of a foundation of the portable building seated on a concrete slab inside a production facility.

FIG. 6 is a diagram representing an isometric view of a cabinet for storing hazardous materials disposed in an interior space of a portable building.

FIG. 7 is a diagram representing a plan view of the interior space of a portable building containing a plurality of cabinets and a freezer in accordance with one embodiment.

FIG. 8 is a block diagram identifying components of an electrical system installed in the portable building depicted in FIG. 7.

FIG. 9 is a diagram representing an isometric view of a cabinet for storing hazardous material when the cabinet doors are closed.

FIG. 10 is a diagram representing an isometric view of a cabinet for storing hazardous material when the cabinet doors are open.

Reference will hereinafter be made to the drawings in which similar elements in different drawings bear the same reference numerals.

### DETAILED DESCRIPTION

Illustrative embodiments of a storage system for containing hazardous materials at a production facility are described in some detail below. However, not all features of an actual implementation are described in this specification. A person skilled in the art will appreciate that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Storage systems of the type disclosed herein can be deployed in many production facility, including facilities where vehicles (such as aircraft, trains, automobiles, boats, trucks, etc.) are produced. For the sake of illustration, a method for deploying portable storage buildings will now be described with reference to an aircraft production facility.

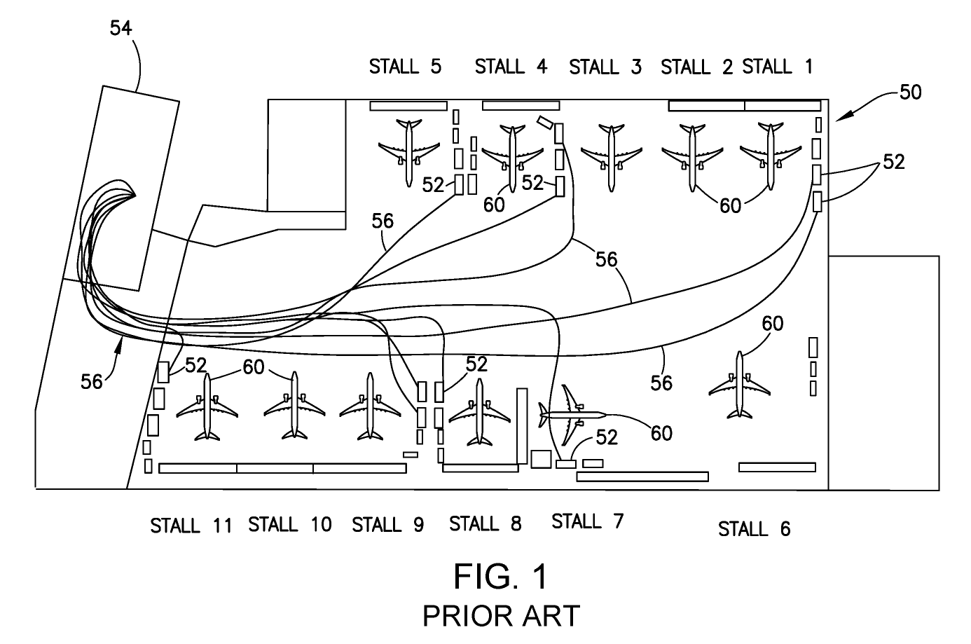

FIG. 1 shows a facility configuration layout for an aircraft production facility 50 having a storage building 54 located outside but near to the production facility. Because the storage building 54 is permanently installed, it is neither portable nor rapidly deployable. The storage building 54 typically has an interior space partially occupied by open shelves (not shown in FIG. 1). Containers of hazardous material are typically seated on the open shelves during storage. Because storage building 54 is not compartmentalized, fire can propagate throughout the entire interior space of the building. Given the large capacity of such a storage building, a fire inside the storage building can be substantial and thus requires an adequate fire protection measures. For example, the storage building 54 is connected to a supply of water (not shown in FIG. 1) for fire control and incorporates a catch basin for containing used fire control water and/or leaked hazardous material. If hazardous material is spilled, the catch basin (which is located underneath the floor) must be cleaned. The storage building 54 is also equipped with a monitoring system (e.g., smoke/fire detectors) and water sprinklers (not shown in FIG. 1) which are activated in response to an alarm signal from the monitoring system.

The placement of storage building 54 outside and at a distance from the aircraft production facility 50 necessitates that personnel who want to use a hazardous material at a stall inside the facility must travel back and forth along the paths 56 indicated by non-linear lines in FIG. 1. Each line represents a path of travel extending from the storage building 54 to a respective stall in which a respective aircraft 60 is parked. More specifically, a person may carry a container filled with hazardous material from the storage building 54 to one of a plurality of sheds 52 which are placed between the aircraft 60. These distances result in lost time and reduced productivity as personnel travel between a shed 52 and the storage building 54.

The placement and installation process for storage building 54 renders such building fixed or considered as a monument. Thus, if a plan were adopted to reconfigure the facility configuration layout of the aircraft production facility 50 to accommodate different-sized structures or to be repurposed, it would be difficult and expensive to relocate storage building 54 within the aircraft production facility 50. A relocation of storage building 54 would require digging water pipes to the new location, and passing the requirements of a permitting process, a process that could take days, if not weeks, and would have high associated costs.

Given the storage capacity of storage building 54, it is purposefully sited at an edge of the aircraft production facility 50 and not inside it for at least two reasons: (1) overall site fire protection purposes; and (2) overall site layout optimization to avoid interference with the free movement of vehicles inside the facility.

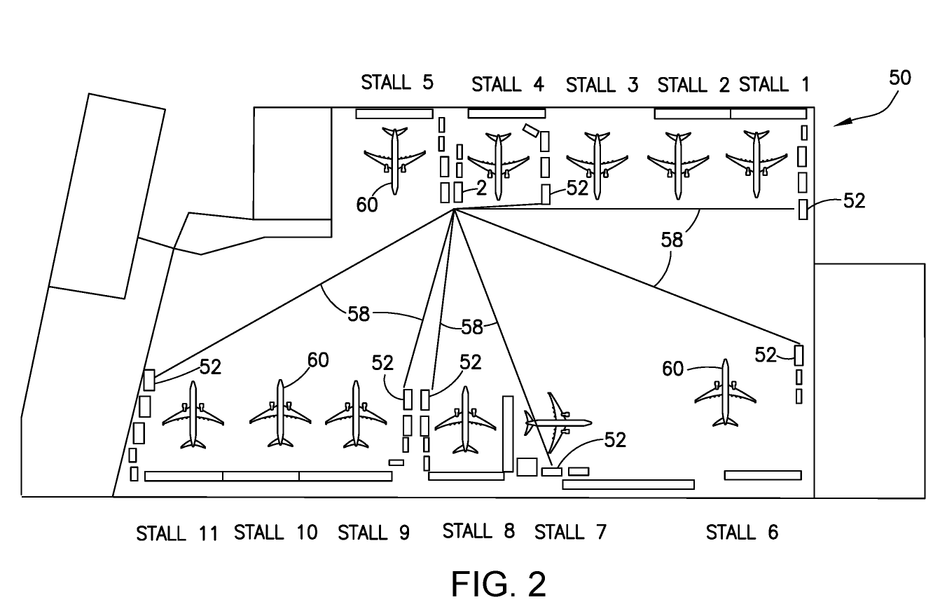

In contrast to the permanent storage installation depicted in FIG. 1, FIG. 2 shows a facility configuration layout for an aircraft production facility 50 that has a portable building 2 for storing hazardous materials located within the facility. Because the portable building 2 is not permanently installed, it is both portable and rapidly deployable with only an electrical power hookup being needed. When stalls within the aircraft production facility 50 are moved, the portable building 2 can be moved to a location that reduces the travel time between the portable buildings and points of use.

In accordance with one method for storing hazardous or flammable materials within the production facility, the following steps are performed: (a) placing the portable building 2 at a first location within the aircraft production facility 50 in accordance with a first facility configuration layout without connecting the portable building to a water source using pipes; (b) storing hazardous or flammable materials inside the portable building while the portable building is at the first location; (c) specifying a second facility configuration layout different than the first facility configuration layout; (d) moving the portable building to a second location within the production facility in accordance with the second facility configuration layout without connecting the portable building to a water source using pipes; and (e) storing hazardous or flammable materials inside the portable building while the portable building is at the second location. Although the portable building 2 is not connected to water at either the first location or the second location, by maintaining the volume levels of the stored hazardous production materials below specified thresholds, the portable building 2 will be in compliance with the applicable safety code governing the storage of hazardous or flammable materials.

More specifically, the portable building 2 has an interior space partially occupied by one or more cabinets (not shown in FIG. 2) for storing hazardous material. Each cabinet is constructed and designed so that, when properly closed, the cabinet prevents any fire and spillage inside the cabinet from spreading outside the cabinet. Containers of hazardous material can be placed on shelves inside the cabinets during storage. Because the space inside each cabinet is compartmentalized, fire is prevented from propagating beyond one shelf in one cabinet.

In addition, the portable building 2 is not equipped with an automatic water-based fire suppression system (e.g., it has no water sprinklers). Therefore, the portable building 2 need not be connected to a supply of water. Also, because each cabinet inside the portable building has a catch basin for containing spilled hazardous material, the portable building 2 need not be designed with a catch basin for capturing spilled or leaked hazardous material. If hazardous material is spilled inside a cabinet, the catch basin underneath the bottom of the cabinet should contain the spillage and prevent it from reaching the floor of the portable building 2. However, preferably the floor, walls and ceiling of the portable building 2 are sealed for easy clean-up in the event that hazardous material does escape from a cabinet.

In accordance with one embodiment, the floor of the portable building 2 comprises a layer of non-combustible underneath sealed textured aluminum plate, the exterior walls comprise metal sheeting fastened to studs, and the interior walls comprise textured vinyl panels glued to gypsum panels, the gypsum panels in turn being attached to fiberglass-reinforced panels that are attached to the studs. The floor-to-wall joints are sealed using silicone caulking to limit spills from escaping the building interior.

Containers of hazardous material for use within the aircraft production facility 50 can be stored inside the portable building 2. The production personnel may move selected containers from the portable building to points of use or to sheds adjacent to such points of use. The placement of portable building 2 inside the aircraft production facility 50 allows a person to travel a shorter distance in order to move a hazardous material container from the portable building 2 to a shed 52. The respective paths of travel from portable building 2 to respective sheds 52 are indicated by straight lines in FIG. 2. Because the paths of travel between the portable building 2 and sheds 52 (shown in FIG. 2) are shorter than the paths of travel between the storage building 54 and sheds 52 (shown in FIG. 1), the amount of time lost to travel by personnel can be reduced.

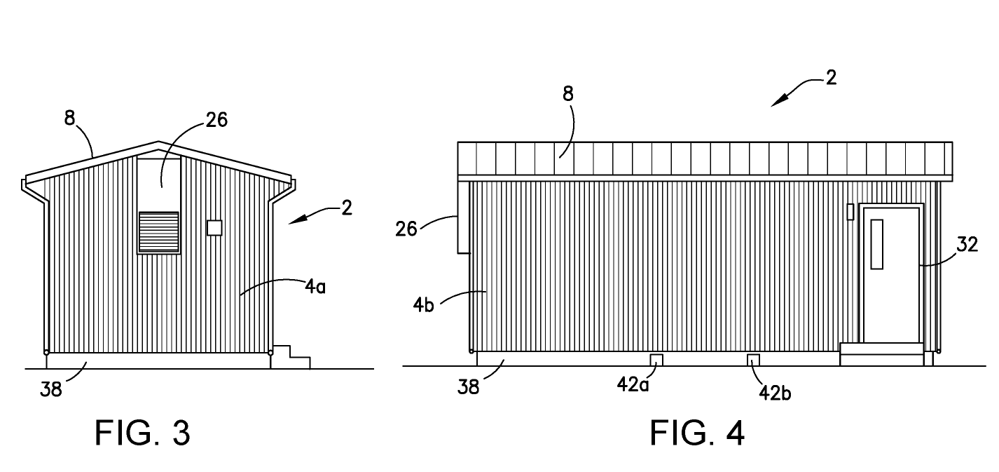

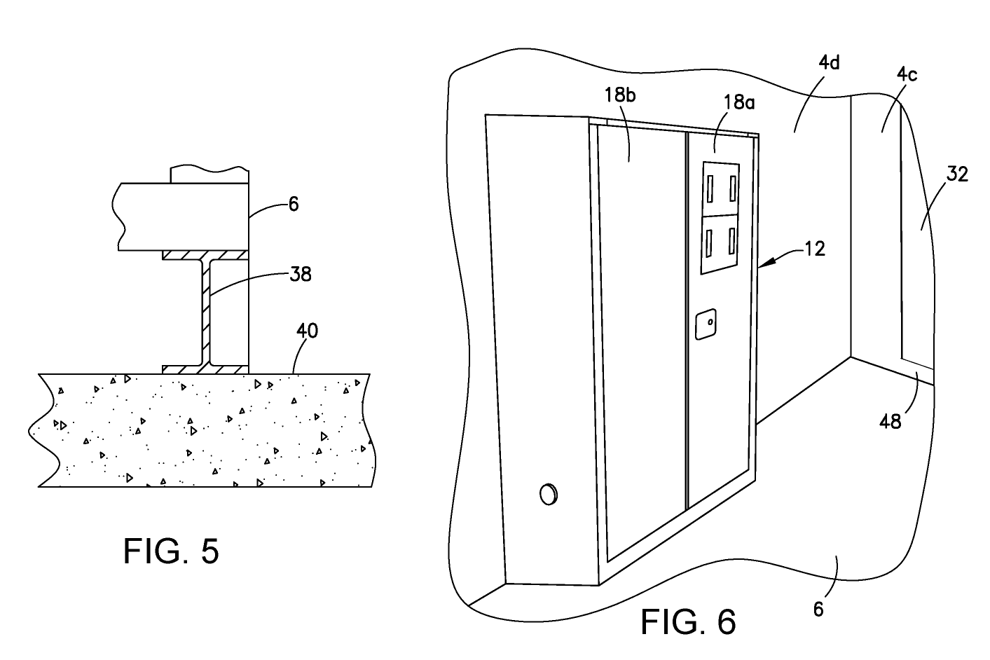

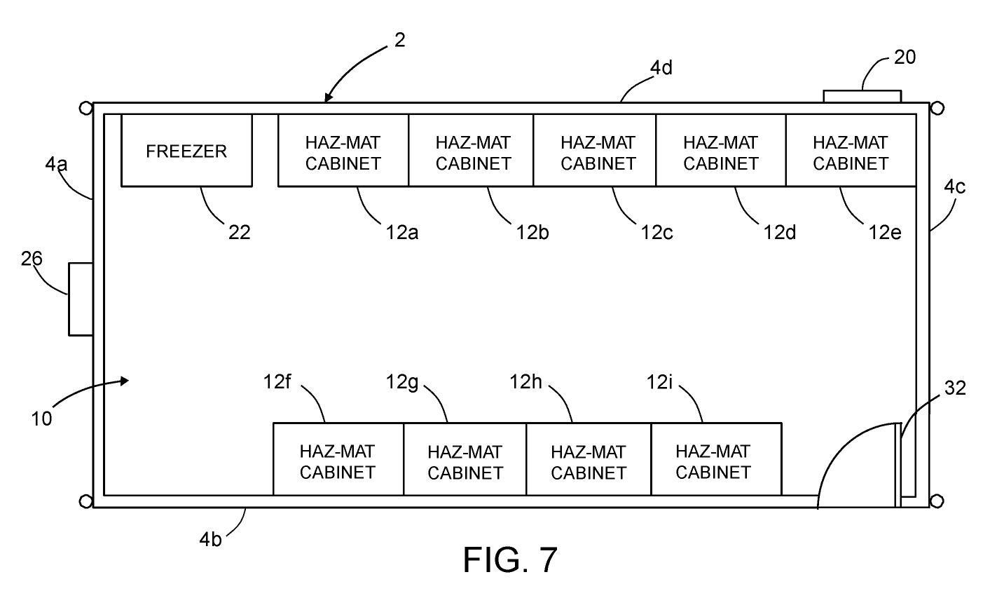

FIGS. 3 and 4 are diagrams representing end and side views respectively of a portable building 2 for storing hazardous materials in accordance with one embodiment. The portable building 2 has four walls arranged to form a rectangle (only end wall 4a is visible in FIG. 3 and only side wall 4b having a door 32 is visible in FIG. 4, but see walls 4a-4d in FIG. 7), a floor (not visible in FIGS. 3 and 4, but see floor 6 in FIG. 5, which rests on a base frame 38), and a roof 8, all constructed of non-combustible materials. A pressure relief vent (not shown in drawings) may be incorporated in the roof 8. That relief vent is in fluid communication with a surface-mounted grill inside the portable building 2 via a duct (not shown in the drawings).

As best seen in FIG. 5, the floor 6 is supported on a concrete slab 40 by a wide-flange base frame 38 made of galvanized steel. The concrete slab 40 is part of the aircraft production facility 50. Preferably the opposing sides of base frame 38 are each designed with a pair of forklift pockets 42a and 42b (shown in FIG. 4) so that the portable building 2 can be lifted and moved using a forklift. In the alternative, the base frame 38 may be coupled to a set of retractable wheels to allow towing when the wheels are extended or may be mounted on wheels and coupled to extendible feet which lift the portable building 2 with wheels off the ground to prevent movement at the installation site.

In the embodiment shown in FIG. 3, an HVAC unit 26 is mounted to the exterior of wall 4a of the portable building 2. In the alternative, the HVAC unit 26 could be mounted on any other wall. The HVAC unit 26 is in fluid communication with the interior space (not shown in FIG. 3) of the portable building 2, which space is bounded by the interior surfaces of the walls, an interior ceiling and the floor 6 of the portable building 2. In accordance with one embodiment, the HVAC unit 26 is in fluid communication with the interior space via insulated supply and return metal ducts installed above the ceiling of the portable building 2. The HVAC unit 26 can be operated to control the climate (i.e., temperature and humidity) of the interior space of the portable building 2. In particular, the HVAC unit 26 provides adequate temperature and humidity control for preventing spoilage or fuming of the hazardous or flammable materials stored inside portable building 2. The HVAC unit enables re-use of the stored products after a duration of time in storage. In accordance with the embodiment depicted in FIG. 3, the HVAC unit 26 comprises a wall-hung heat pump unit that provides heating and cooling. In accordance with alternative embodiments, the HVAC unit could be a standalone unit instead of a wall-hung unit. The HVAC unit may be controlled by a 7-day programmable wall-mounted thermostat with adjustable temperature located inside portable building 2.

FIG. 6 is a diagram representing an isometric view of a cabinet 12 for storing hazardous materials disposed in an interior space of a portable building. (Such cabinets are sometimes referred to as “safety cabinets”.) As will be explained in more detail below, the cabinet 12 is constructed and designed so that when doors 18a and 18b of the cabinet 12 are closed (as depicted in FIG. 6), the cabinet 12 will prevent fire and spillage inside the cabinet 12 from spreading outside cabinet 12. In this respect and other respects, the cabinet 12 has a construction designed to contain fire and spills in compliance with the applicable safety codes.

Only portions of walls 4c and 4d and floor 6 of the portable building 2 are shown in FIG. 6. The floor 6 is sealed to the walls to prevent leakage of liquid from the portable building in the event of a spill. The door 32 is mounted in wall 4c. The wall 4c to which the door 32 is mounted comprises a wall section 48 that extends upward from the floor 6 to a bottom of the door 32. Because the floor 6 does not incorporate a liquid collection system, the door 32 is raised from the floor 6 by a certain threshold (e.g., 1 or more inches) to prevent leakage of spilled liquids through the horizontal gap separating the bottom of door 32 from wall section 48.

FIG. 7 is a diagram representing a plan view of the interior space 10 of a portable building 2 containing a plurality of cabinets 12a through 12i and a freezer 22 in accordance with one embodiment. The normal temperature for storing hazardous materials is 60 to 70 deg F. The freezer 22 is for exothermic materials that set at room temperature. Such materials are maintained at a lower temperature (e.g. −40 deg F). Each of the cabinets 12a-12i has a construction designed to contain fire and spills in compliance with the applicable safety code.

In the specific configuration shown in FIG. 7, the freezer 22 and cabinets 12a-12e are arranged along a side wall 4d of the portable building 2, while cabinets 12f-12i are arranged along the opposing side wall 4b, but it may be appreciated that the cabinets and freezer can be arranged in accordance with alternative configurations. Preferably, the cabinets 12a-12i and freezer 22 are mounted to the side walls 4b, 4d and/or floor 6 to ensure that the cabinets 12a-12i do not tip over during transportation of the portable building 2.

After the portable building 2 has been moved to a new location, it must be hooked up to a source of electrical power. This can be accomplished easily and quickly by connecting one or more electrical cables (not shown in FIG. 7) to an electrical connector panel 20 which is mounted on the exterior of wall 4b of the portable building 2. In accordance with one implementation, the electrical connector panel 20 is a circuit panelboard having a main circuit breaker.

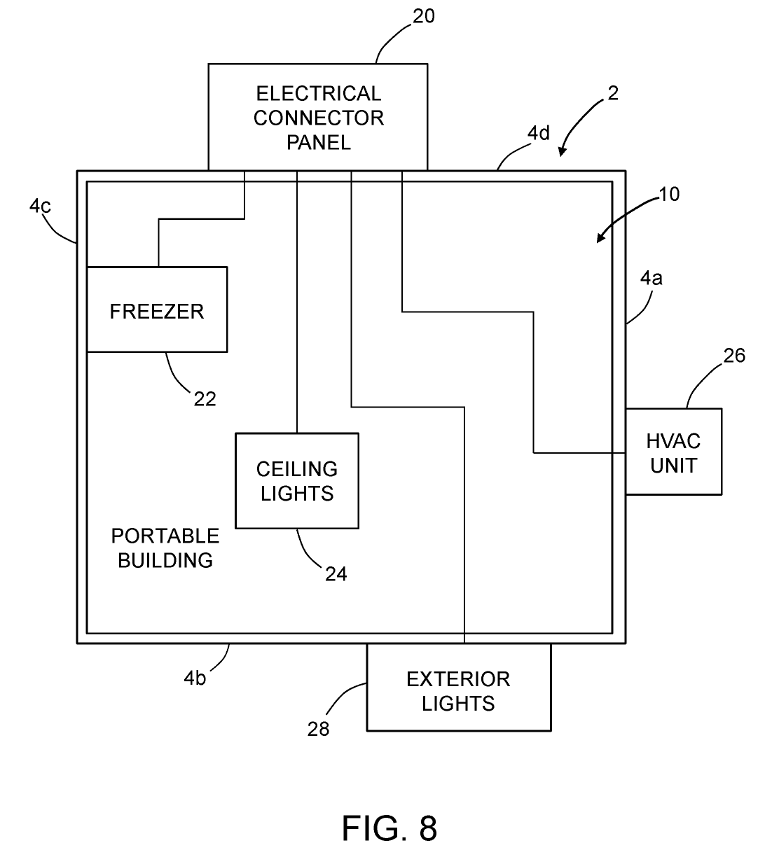

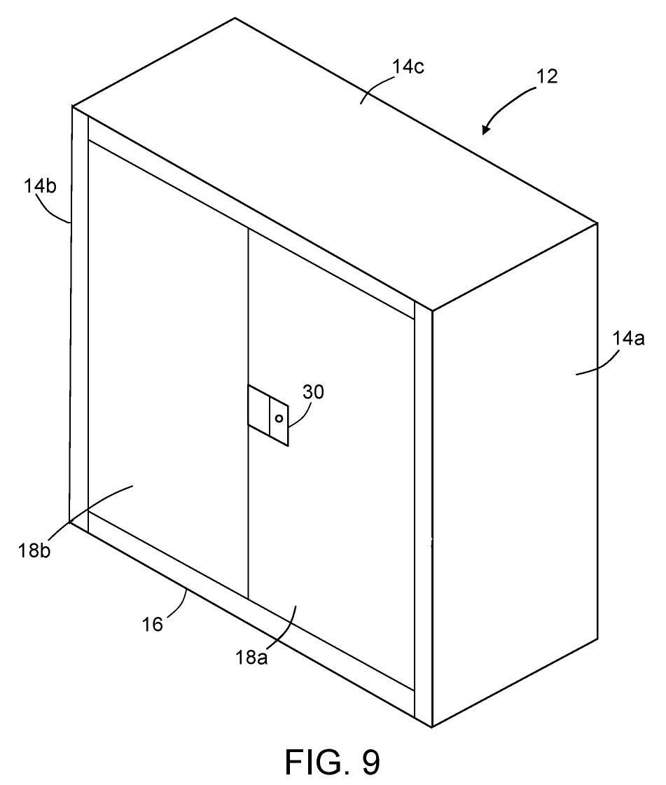

As shown in FIG. 8, electrical power is provided to various electrical components via the electrical connector panel 20. Those electrically powered components include the following: (a) the freezer 22 inside the interior space 10 of the portable building 2; (b) a plurality of interior ceiling lights 24; (c) the HVAC unit 26 mounted to the exterior of end wall 4a of the portable building 2; and (d) a plurality of exterior lights 28 mounted to the exterior of side wall 4b of the portable building 2.

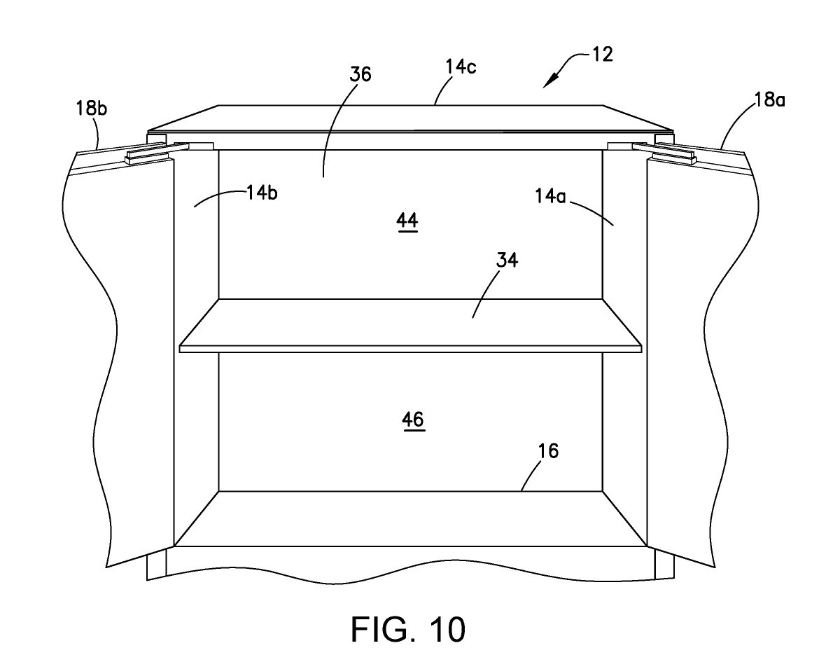

FIGS. 9 and 10 are diagrams representing respective isometric views of a cabinet 12 for storing hazardous material when the cabinet 12 is closed (see FIG. 9) and when the cabinet 12 is open (see FIG. 10). Preferably, the cabinet 12 is a hazardous materials storage cabinet of the type disclosed in U.S. Pat. No. 8,172,344. Such cabinets are commercially available from Justrite Manufacturing Company L.L.C., Des Plaines, Ill.

The cabinet 12 depicted in FIGS. 9 and 10 comprises a right side 14a, a left side 14b, and a top 14c, each of which comprise metal double walls separated by an airspace, and a bottom 16 that includes a liquid-tight containment sump (not shown). The back of cabinet 12, which also comprises metal double walls separated by an airspace, is not visible in FIGS. 9 and 10. The left side 14a, right side 14b, top 14c, bottom 16 and back 36 of cabinet 12 form an enclosure having an opening. The cabinet 12 further comprises a vent with a built-in flame arrester (not shown in FIGS. 9 and 10) which is in fluid communication with the interior volume of the enclosure.

The front of the cabinet 12 has a right door 18a and a left door 18b which selectively cover the opening in the enclosure. In alternative embodiments, the cabinet 12 can have a single door to selectively cover the opening of the enclosure. In FIG. 9, doors 18a and 18b are shown in respective closed positions; in FIG. 10, doors 18a and 18b are shown in respective open positions. Each door has double walls separated by an airspace. The cabinet further comprises a latch system that includes a paddle handle 30. The latch system controls the opening of doors 18a and 18b through operation of the paddle handle 30.

As seen in FIG. 10, the bottom 16 of the cabinet 12 can be used as a shelf. In addition, the cabinet 12 depicted in FIG. 10 has a shelf 34. The ends of shelf 34 can be attached or coupled to shelf mounts (not shown) affixed to the interior surfaces of left side 14a and right side 14b of the cabinet 12. In the alternative, the cabinet 12 may be provided with additional shelves.

Preferably, the shelf 34 is a spill-sloped shelf for directing fluid into the containment sump at the bottom 16 of the cabinet 12, as disclosed in the aforementioned patent. All the waste from a fire will be held in the containment sump of the cabinet 12, which has a sealed bottom. Additionally, the right and left sides 14a and 14b, back 36, doors 18a and 18b, and shelf 34 of the cabinet 12 are designed so that when the doors 18a and 18b are closed, the interior volume 44 above the shelf 34 is effectively sealed off from the interior volume 46 below the shelf 34, at least to the extent that fire in one interior volume cannot spread to the other interior volume. (For example, as depicted in FIG. 10, the front edge of shelf 34 can be set back from the front edges of the sides 14a and 14b to allow the interior surfaces of the double-walled doors 18a and 18b to abut or nearly abut the front edge of shelf 34 when the cabinet 12 is closed.) After a fire, the affected cabinets will be removed and replaced. If the internal wall and ceiling material in the portable building 2 is damaged by the heat, it can be easily replaced in sections and any smoke residue can be wiped off.

While storage systems for containing hazardous materials have been described with reference to particular embodiments, it will be understood by those skilled in the art that various changes may be made and equivalents may be substituted for elements thereof without departing from the scope of the teachings herein. In addition, many modifications may be made to adapt a particular situation to the teachings herein without departing from the essential scope thereof. Therefore it is intended that the claims set forth hereinafter not be limited to the disclosed embodiments.

In the absence of explicit language indicating a particular sequence of steps, the method claims set forth hereinafter should not be construed to require that the steps recited therein be performed in alphabetical order (any alphabetical ordering in the claims is used solely for the purpose of referencing previously recited steps) or in the order in which they are recited. Similarly, in the absence of explicit language indicating non-concurrent steps, the method claims set forth hereinafter should not be construed to exclude any portions of two or more steps being performed concurrently.

1. A method for storing hazardous or flammable materials for use in a production facility, comprising:
(a) placing a portable building at a first location within the production facility in accordance with a first facility configuration layout and without connecting the portable building to a water source using pipes;
(b) storing hazardous or flammable materials inside the portable building in compliance with an applicable safety code governing storage of hazardous or flammable materials while the portable building is at the first location;
(c) specifying a second facility configuration layout different than the first facility configuration layout;
(d) moving the portable building to a second location within the production facility in accordance with the second facility configuration layout without connecting the portable building to a water source using pipes; and
(e) storing hazardous or flammable materials inside the portable building in compliance with the applicable safety code while the portable building is at the second location.

2. The method as recited in claim 1, further comprising placing a plurality of cabinets inside the portable building, each of the cabinets having a construction designed to contain fire and spills in compliance with the applicable safety code, wherein steps (b) and (e) each comprise storing hazardous or flammable materials inside the plurality of cabinets.

3. The method as recited in claim 1, further comprising controlling a climate in the interior of the portable building using an HVAC unit mounted to an exterior of the portable building, wherein the HVAC unit provides adequate temperature and/or humidity control enabling use of the hazardous or flammable materials after storage at either of the locations.

4. A storage system for hazardous or flammable materials comprising:
a portable building not equipped with an automatic fire suppression system and not connected to a water source by pipes; and
a cabinet disposed in the interior space of the portable building, wherein the cabinet is constructed to contain fire and spills in compliance with an applicable safety code governing storage of hazardous or flammable materials without any connection to a water source.

5. The storage system as recited in claim 4, wherein the portable building contains neither a smoke detector nor a fire monitoring system.

6. The storage system as recited in claim 5, wherein the portable building comprises a plurality of walls, a door mounted to one of the plurality of walls, and a floor that is sealed to the walls to prevent leakage of liquid from the portable building in case of a spill, wherein the wall to which the door is mounted comprises a wall section that extends upward from the floor to a bottom of the door, and the floor of the portable building does not incorporate a liquid collection system.

7. The storage system as recited in claim 6, wherein the walls are made of non-combustible material and are sealed to each other to prevent leakage of liquid from the portable building.

8. The storage system as recited in claim 5, further comprising:
a power connection mounted to the portable building; and
an HVAC unit mounted to an exterior of the portable building,
wherein the HVAC unit provides adequate temperature and/or humidity control to enable use of the stored hazardous or flammable materials following a time duration in storage.

9. The storage system as recited in claim 4, wherein the cabinet comprises metal double walls separated by an air space.

10. The storage system as recited in claim 4, wherein the cabinet comprises a liquid-tight containment sump.

11. The storage system as recited in claim 4, wherein the cabinet comprises a vent with a built-in flame arrester.

12. The storage system as recited in claim 4, wherein the cabinet comprises a shelf that is configured so that fire in an interior volume below the shelf will not spread into an interior volume above the shelf.

13. The storage system as recited in claim 12, further comprising a container seated on the shelf, the container containing hazardous material.

14. A storage system comprising:
a portable building that is not connected to a water source using pipes and has an interior space; and
a plurality of cabinets disposed in the interior space of the portable building, wherein each cabinet of the plurality of cabinets comprises metal double walls separated by an air space and a liquid-tight containment sump.

15. The storage system as recited in claim 14, wherein each cabinet is constructed to contain fire and spills in compliance with an applicable safety code governing the storage of hazardous or flammable materials without any connection to a water source.

16. The storage system as recited in claim 14, wherein the portable building is not equipped with any of the following: an automatic fire suppression system, a smoke detector, and a fire monitoring system.

17. The storage system as recited in claim 14, wherein the portable building comprises a plurality of walls, a door mounted to one of the plurality of walls, and a floor that is sealed to the walls to prevent leakage of liquid from the portable building in case of a spill, wherein the wall to which the door is mounted comprises a wall section that extends upward from the floor to a bottom of the door.

18. The storage system as recited in claim 17, wherein the floor of the portable building does not incorporate a liquid collection system.

19. The storage system as recited in claim 17, wherein the walls are made of non-combustible material and are sealed to each other to prevent leakage of liquid from the portable building.

20. The storage system as recited in claim 14, further comprising:
a power connection mounted to the portable building; and
an HVAC unit mounted to an exterior of the portable building,
wherein the HVAC unit provides adequate temperature and humidity control for preventing spoilage or fuming of hazardous or flammable materials.
